(19) United States
(12) Patent Application Publication
(10) Pub. No.: US 2016/0107487 A1
(43) Pub. Date: Apr. 21, 2016

(54) PNEUMATIC VEHICLE TIRE

(71) Applicant: Continental Reifen Deutschland GmbH, Hannover (DE)

(72) Inventors: Vipin Rajan, Hannover (DE); Alexis Keathley, Hannover (DE); Hendrik Meyer, Bad Nenndorf (DE)

(21) Appl. No.: 14/981,460

(22) Filed: Dec. 28, 2015

Related U.S. Application Data
(63) Continuation of application No. PCT/EP2014/056647, filed on Apr. 3, 2014.

(30) Foreign Application Priority Data
Jun. 28, 2013 (DE) 10 2013 106 778.6

(51) Int. Cl. B60C 9/20; B60C 9/00

(52) U.S. Cl. CPC B60C 9/2006; B60C 9/0007; B60C 9/0064; B60C 2009/0085; B60C 2009/209; B60C 2009/2077; B60C 2009/2083

(57) ABSTRACT

A pneumatic vehicle tire has a radial configuration and includes a belt assembly having at least three plies including two working plies and a protective ply arranged radially outwardly with respect to the two working plies. Each of the three plies has reinforcements and each of the reinforcements includes at least one steel filament. The reinforcements of each of the plies are arranged mutually parallel and spaced from each other. The steel filaments have a filament diameter in a range of 0.10 mm to 0.35 mm. The reinforcements have a reinforcement diameter in a range of 0.20 to 0.85 mm. The reinforcements of the protective ply have a rupture strength lying in a range of 15 kN/dm to 95 kN/dm and the reinforcements of the protective ply are arranged in the protective ply with a density in a range of 50 to 120 ends per decimeter.

### CROSS REFERENCE TO RELATED APPLICATIONS

This application is a continuation application of international patent application PCT/EP2014/056647, filed Apr. 3, 2014, designating the United States and claiming priority from German application 10 2013 106 778.6, filed Jun. 28, 2013, and the entire content of both applications is incorporated herein by reference.

### FIELD OF THE INVENTION

The invention relates to a radial pneumatic vehicle tire, in particular a tire of a commercial vehicle, having a belt assembly including at least three belt plies, of which two belt plies are configured as so-called working plies and of which the radially outermost belt ply is configured as a so-called covering ply, each of these belt plies having reinforcements of steel cord embedded in elastomer and the steel cords of each belt ply being respectively arranged parallel to one another and spaced apart from one another.

### BACKGROUND OF THE INVENTION

Tires of commercial vehicles with a breaker belt that has two working plies and a covering ply are known to a person skilled in the art. The breaker belt of commercial vehicle tires usually has four plies, which include steel cords embedded in rubber compounds. In the case of a 4-ply belt, the radially innermost ply is referred to as the “1st belt ply” or according to its function as a “barrier ply”. Arranged radially outside this are the 2nd belt ply and the 3rd belt ply with the function of so-called “working plies”. The radially outer working ply is covered by the 4th belt ply, the so-called “covering ply” or “protective ply”.

The steel cords of the 1st belt ply generally have an angle of >45° with respect to the circumferential direction. The 1st belt ply is referred to as a so-called “barrier ply” on account of its function as a barrier against the working plies moving in the circumferential direction. The steel cords of the two working plies typically have an identical angle of between 15° and 30° with respect to the circumferential direction of the tire, the steel cords of the one working ply being inclined oppositely to the steel cords of the other working ply with respect to the circumferential direction of the tire. So, the steel cords of the one working ply are arranged crossing the steel cords of the other working ply. The working plies accept shearing and tensile forces, bear the main load in the breaker belt and are therefore of particular importance for the durability of the belt.

The 4th belt ply has the function of a protective ply for the two working plies lying thereunder, in that it represents a barrier for stones or other objects that could penetrate through the tread assembly. Without the protective ply, the cords of the working plies would be damaged by penetrating stones and be more exposed to corrosion, which in the end would reduce the bearing load, the durability and the retreadability of the tire, if the tire is retreadable.

It is for example known to use steel cords of the construction 3×0.20+6×0.35 for the protective ply. This steel cord has a core strand of 3 twisted together steel filaments of 0.20 mm in diameter, which are surrounded by 6 filaments of 0.35 mm in diameter. It is also known to use steel cords of the construction 1×0.40+5×0.40 for the protective ply. This steel cord has a core filament of 0.40 mm in diameter, which is surrounded by 5 filaments of 0.40 mm in diameter. The rupture strength of the aforementioned cords lies between 55 and 130 kN/dm.

This gives a cord diameter of approximately 1.13 mm and, as a rubberized ply, a thickness of between approximately 1.60 mm and 1.85 mm. These cords are arranged in the protective ply with a density of 34 to 65 ends per decimeter (epdm).

Efforts are continually being made to improve the pneumatic vehicle tire with regard to its durability and, if additionally possible, lower its weight and its production costs.

### SUMMARY OF THE INVENTION

It is an object of the invention to provide a pneumatic vehicle tire, in particular a commercial vehicle tire, having an at least three-ply belt assembly configured in such a manner that its durability is improved, its weight is lowered and in addition its production costs are lowered.

The object is, for example, achieved in that the steel filaments of the reinforcements of the protective ply have a filament diameter of between 0.10 mm and 0.35 mm, a reinforcement diameter being between 0.20 mm and 0.85 mm, each reinforcement of the protective ply has a rupture strength of between 15 kN/dm and 95 kN/dm, and in that these reinforcements are arranged in the protective ply with a density of between 50 and 120 ends per decimeter (epdm).

The invention provides a commercial vehicle tire having an at least three-ply belt which is improved in its protective ply with regard to its function of “protecting” the plies arranged under it with respect to penetrating stones or other objects, by “intercepting” these stones or other objects, with regard to its weight and also with regard to its production costs.

Approximately the same amount of steel cord is arranged in the protective ply of the tire according to the invention as in the protective ply of a tire of the prior art. However, the amount of steel is distributed differently: on account of its smaller cord diameter, each cord of this protective ply of the tire according to the invention has a smaller amount of steel, while the cord density however is increased. This measure results in an increase in the flexibility of the breaker belt, which has a positive effect on the durability and the rolling resistance of the tire. Furthermore, the risk of so-called “groove cracks” occurring is reduced, since as a result of the protective ply there are smaller abrupt changes in stiffness under the groove concerned.

The higher cord density in the protective ply has the effect that the protective ply is improved with regard to its protective function. The higher cord density forms a more effective “grid” against penetrating objects.

Furthermore, the cord has a smaller diameter than a cord of the prior art, so that, with a higher density of cords in the protective layer, there is also a saving in elastomer material that embeds the cords.

The rupture strength is determined in accordance with ASTMD 885, which is incorporated herein by reference.

In an embodiment of the invention, the reinforcements of the protective ply are monofilaments of the construction 1×0.30, which are arranged in the protective ply with a density of between 90 and 120 ends per decimeter (epdm).

In another embodiment, the reinforcements of the protective ply are steel cords of twisted together steel filaments, which preferably have the construction 2×0.30, 2+2×0.32, 2+2×0.28, 2×0.15 or 3×0.10.

It is advantageous if the reinforcements of the protective ply include steel of the strength class HT or higher, whereby the highest possible strength per cord volume is achieved.

The following table shows cord constructions that are used in the covering ply of a pneumatic vehicle tire according to the invention (rows 2-6) in comparison with cords of the prior art (rows 1a and 1b).

| | | Outside | | Cord-to- | |
|---|---|---|---|---|---|
| | | diameter of | | cord | Rupture |
| | | the cord | | spacing | strength |
| | Cord construction | (in mm) | epdm | (in mm) | (in kN/dem) |
| 1a | 3 × 0.20 + 6 × 0.35 | 1.13 | 60 | 0.54 | 100 |
| 1b | 3 × 0.20 + 6 × 0.35 | 1.13 | 34 | 1.81 | 57 |
| 2 | 2 × 0.30 | 0.60 | 95 | 0.46 | 42 |
| 3 | 2 + 2 × 0.32 | 0.83 | 56 | 0.97 | 53 |
| 4 | 2 + 2 × 0.28 | 0.74 | 65 | 0.81 | 43 |
| 5 | 2 × 0.15 | 0.30 | 110 | 0.61 | 15 |
| 6 | 3 × 0.10 | 0.22 | 120 | 0.62 | 15 |

For each cord construction, the outside diameter of this cord, the density of its arrangement in the covering ply, the resultant cord-to-cord spacing and its rupture strength are specified.

Lower material costs of the covering ply are achieved by a smaller cord diameter, and consequently a smaller ply thickness with at the same time a smaller cord-to-cord spacing.

### BRIEF DESCRIPTION OF THE DRAWINGS

The invention will now be described with reference to the drawings wherein:

FIG. 1 shows a partial cross section through one half of a pneumatic vehicle tire in the region of the breaker belt and the tread; and,

FIG. 2 shows a cross section through a steel cord of the protective ply of the tire of FIG. 1.

### DESCRIPTION OF THE PREFERRED EMBODIMENTS OF THE INVENTION

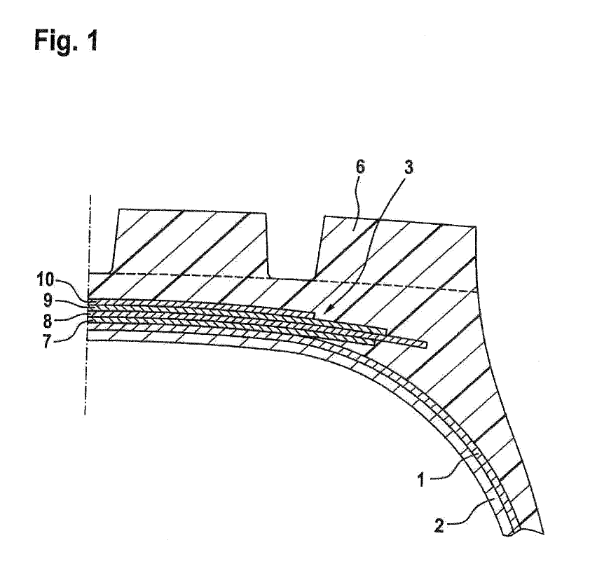

FIG. 1 shows a cross section through the tread and the breaker belt region of a pneumatic vehicle tire for trucks in a customary standard construction having a carcass 1 with steel cords as reinforcements, an air-tight inner layer 2, a multi-ply belt assembly 3 and a profiled tread 6.

The belt assembly 3 has four belt plies 7, 8, 9 and 10, the fourth, radially outermost belt ply having the smallest width of all the plies and forming the so-called protective ply 10. The first belt ply is the so-called barrier ply 7, the second belt ply and the third belt ply are the so-called working plies (8, 9). The widest belt ply is the second belt ply 8, which accordingly completely covers over the first belt ply 7. The third belt ply 9 is somewhat wider than or the same width as the first belt ply 7. The fourth belt ply 10 may also be made the same width as the third belt ply 9. All of the belt plies (7, 8, 9, 10) include reinforcements of steel cord embedded in a rubber compound, the belt rubberizing compound, the steel cords being arranged parallel to one another and spaced apart from one another.

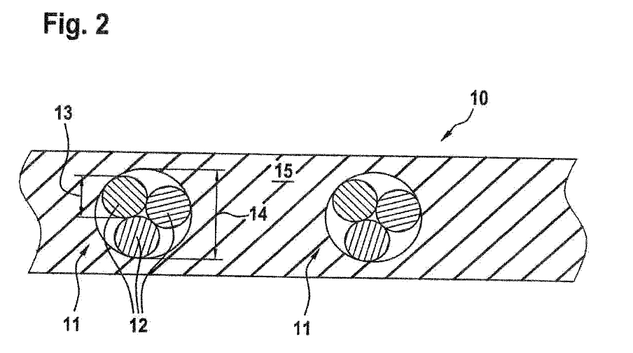

FIG. 2 shows a cross section through the protective ply 10 of the tire from FIG. 1. The protective ply 10 has steel cords 11 of the strength class HT, which are embedded in a rubber compound 15. The steel cords 11 are arranged in this protective ply 10 parallel to one another and spaced apart from one another. The steel cords 11 have the construction 3×0.10, which means that three steel filaments 12 are twisted together. The filament diameter 13 is 0.10 mm. The reinforcement diameter 14 is 0.22 mm. Its rupture strength is 15 kN/dm. The reinforcements 11 are arranged in the protective ply 10 with a density of approximately 120 ends per decimeter (epdm).

It is understood that the foregoing description is that of the preferred embodiments of the invention and that various changes and modifications may be made thereto without departing from the spirit and scope of the invention as defined in the appended claims.

### LIST OF DESIGNATIONS

(part of the description)
1 carcass
2 inner layer
3 belt assembly
6 tread
7 barrier ply (1st belt ply)
8 working ply (2nd belt ply)
9 working ply (3rd belt ply)
10 protective ply (4th belt ply)
11 reinforcement/steel cord
12 filament
13 filament diameter
14 cord diameter

What is claimed is:

1. A pneumatic vehicle tire having a radial configuration, the pneumatic vehicle tire comprising:
a belt assembly having at least three plies including two working plies and a protective ply arranged radially outwardly with respect to said two working plies;
each of said at least three plies having reinforcements;
each of said reinforcements including at least one steel filament;
said reinforcements of each of said plies being arranged mutually parallel and mutually spaced from each other;
said steel filaments of said reinforcements of said protective ply having a filament diameter lying in a range of 0.10 mm to 0.35 mm;
said reinforcements having a reinforcement diameter lying in a range of 0.20 to 0.85 mm;
said reinforcements of said protective ply having a rupture strength lying in a range of 15 kN/dm to 95 kN/dm; and,
said reinforcements of said protective ply being arranged in said protective ply with a density lying in a range of 50 to 120 ends per decimeter.

2. The pneumatic vehicle tire of claim 1, wherein said reinforcements of said protective ply are monofilaments having a construction of 1×0.30 and are arranged in said protective ply with a density lying in a range of 90 to 120 ends per decimeter.

3. The pneumatic vehicle tire of claim 1, wherein said reinforcements of said protective ply are steel cords of twisted together steel filaments.

4. The pneumatic vehicle tire of claim 3, wherein said steel filaments of said protective ply have a construction of 2×0.30, 2+2×0.32, 2+2×0.28, 2×0.15, or 3×0.10.

5. The pneumatic vehicle tire of claim 1, wherein said steel filaments are of the strength class HT or greater.

6. The pneumatic vehicle tire of claim 1, wherein the pneumatic vehicle tire is a commercial pneumatic vehicle tire.
